(19) United States
(12) Patent Application Publication
(10) Pub. No.: US 2024/0066607 A1
(43) Pub. Date: Feb. 29, 2024

(54) CUTTING INSERT AND CUTTING TOOL

(71) Applicant: ISCAR, LTD., TEFEN (IL)

(72) Inventor: GIL HECHT, NAHARIYA (IL)

(73) Assignee: ISCAR, LTD., TEFEN (IL)

(21) Appl. No.: 18/548,944

(22) PCT Filed: Aug. 1, 2021
(86) PCT No.: PCT/IL2021/050926

§ 371 Date: Sep. 5, 2023

(30) Foreign Application Priority Data
Mar. 23, 2021 (JP) 2021-048847

(51) Int. Cl. B23B 29/04

(52) U.S. Cl. CPC B23B 29/043; B23B 2200/0423; B23B 2200/081; B23B 2200/3618; B23B 2200/3681

(57) ABSTRACT

A double sided V-shaped cutting insert includes insert front and back surfaces and a peripheral surface extending therebetween. The peripheral surface has a forward surface, a first planar converging surface, and a first rake surface extending between the forward surface and the first converging surface. A second planar converging surface forms a convergence angle φ, 30°≤φ≤45° with the first converging surface. A second rake surface extends between the forward surface and the second converging surface. In a view perpendicular to the insert front surface, the cutting insert exhibits mirror symmetry about a bisector plane passing between the first and second rake surfaces. The first and second rake surfaces each face away from the bisector plane. The first rake surface tends towards the bisector plane more than the first converging surface, and the second rake surface tends towards the bisector plane more than the second converging surface.

### FIELD OF THE INVENTION

The present invention relates to a cutting insert, and a cutting tool for retaining the cutting insert, and particularly to a such insert and tool for turn grooving metal cutting applications.

### BACKGROUND OF THE INVENTION

For turning tools that are attached to comb-shaped tool posts of a machine tool employing a plurality of turning tools arranged in parallel, they have a narrow pitch from the turning tools attached adjacent thereto. If a turning tool has a bulging part in a Y-axis direction of the adjacent turning tool, when this turning tool is attached to the comb-shaped tool post, the bulging part mentioned above interferes with the adjacent turning tool that is previously attached to the comb-shaped tool post, and this turning tool may not be attached to the comb-shaped tool post. Further, while the adjacent turning tool is used for machining the work material, the bulging portion mentioned above may interfere with the work material and damage the same.

When grooving and cutting off to make a groove on an outer peripheral surface of a cylinder, since the work material driven by a spindle of the machine tool and rotated around the Z axis is cut from the X axis direction, which is the longitudinal direction of the turning tool and the radial direction of the work material, the cutting insert for grooving and cutting off includes a flank facing the X-axis direction and a rake face facing the Y-axis direction. During machining such as grooving or the like, the main component force of cutting resistance acts in the Y-axis direction.

JP-A-2005-74531 (PTL 1) discloses a cutting insert having a substantially equilateral triangle with a cutting edge protruding in the X-axis direction. In a cutting insert having such a shape, it is difficult to provide a surface on which the insert mounting seat supports the cutting insert in the Y-axis direction that receives the main component force of the cutting resistance. In addition, when the insert mounting seat is extended in the X-axis direction up to just below the cutting edge in the Y-axis direction, the thickness of the back metal formed in the wedge-shaped thin wall portion and located between the tip surface of the tool body and the insert mounting seat cannot be secured, and the rigidity of the turning tool decreases. Further, for the substantially equilateral triangular cutting insert, the dimensions of the tightening screw and insert mounting seat are proportional to the dimensions of the inscribed circle of the cutting insert. When the cutting insert is miniaturized, the rigidity of the turning tool is significantly reduced.

JP-T-2003-503218 (PTL 2) discloses a rod-shaped cutting insert extending in the X-axis direction. In a cutting insert having such a shape, since the main component force of the cutting resistance is received by the long insert mounting seat, it is possible to increase the rigidity of the turning tool. On the other hand, since the cutting insert and the insert mounting seat extend up to the shank portion located in the comb-shaped tool post of the machine tool, the cutting insert cannot be replaced unless it is removed from the comb-shaped tool post together with the turning tool. Since two tightening screws are used to fix the cutting insert, it is particularly difficult to loosen or tighten the tightening screws on the base end side of the tool body. When the protrusion amount of the turning tool is increased enough to expose the tightening screw on the base end side from the comb-shaped tool post, the turning tool tends to vibrate during machining, and cutting performance such as machining efficiency and the like deteriorates. The turning tool described in PTL 2 has poor workability, and tends to increase machine tool downtime when replacing cutting inserts.

International Publication No. 2020/178214 (PTL 3) discloses a substantially V-shaped cutting insert having mirror image symmetry based on a symmetry plane perpendicular to the central axis of the mounting hole and a symmetry plane parallel to the central axis. This cutting insert is attached to the tool body to be used, such that the two symmetry planes are parallel to the X-axis direction which is the longitudinal direction of the turning tool. According to the cutting insert described in PTL 3, it allows easier replacing work than the cutting insert of PTL 2, and the distance from the insert mounting seat that receives the main component force of the cutting resistance to the cutting edge of the cutting insert can be shortened as compared with the cutting insert described in PTL 1. However, even with the cutting insert described in PTL 3, the distance from the insert mounting seat that receives the main component force of the cutting resistance to the cutting edge of the cutting insert is slightly distant in the X-axis direction. The main component force of the cutting resistance cannot be received directly under the cutting edge of the cutting insert in the Y-axis direction.

It is an object of the present invention to provide a cutting tool and a cutting insert therefor that significantly reduce or overcome the disadvantages of the prior art.

### SUMMARY OF THE INVENTION

In accordance with the present invention there is provided a double sided V-shaped cutting insert, comprising:
an insert front surface;
an insert back surface; and
a peripheral surface extending between the insert front and back surfaces, the peripheral surface further comprising:
a forward surface;
a first converging surface, being a planar surface;
a first rake surface extending between the forward surface and the first converging surface;
a second converging surface, being a planar surface, and forming a convergence angle φ with the first converging surface, fulfilling the condition: 30°≤φ≤45°;
a second rake surface extending between the forward surface and the second converging surface;
wherein
a bisector plane of the convergence angle is defined between, and equally distanced from, each of the first rake surface and the second rake surface, and the cutting insert exhibits mirror symmetry about the bisector plane, at least in a view taken perpendicular to the insert front surface;
the first rake surface and the second rake surface each face away from the bisector plane; and
the first rake surface tends towards the bisector plane more than the first converging surface, and the second rake surface tends towards the bisector plane more than the second converging surface.

In accordance with another aspect of the present disclosure there is provided a cutting tool, comprising a cutting insert as described above, and a tool holder, the tool holder extending along a longitudinal axis, defining a forward direction and an opposite rearward direction, the tool holder comprising:
an insert seat located at a forward end of the tool holder; and
a shank portion extending from the insert seat in the rearward direction;
wherein
the insert seat comprises:
   a seat support surface;
   a first seat converging wall, extending transversely to the seat support surface, and having a planar first seat abutment portion located thereon;
   a second seat converging wall, extending transversely to the seat support surface, and having a planar second seat abutment portion and a planar third seat abutment portion located thereon, the second and third seat abutment portions being coplanar and spaced apart from one another, the second and third seat abutment portions being parallel to the longitudinal axis, and the second seat abutment portion being located forwardly of the third seat abutment portion, along the longitudinal axis;
the cutting insert is placed in the insert seat, such that the first insert abutment portion abuts the first seat abutment portion, the second and third insert abutment portions abut the second and third seat abutment portions, respectively, and the insert back surface abuts the seat support surface.

In accordance with another aspect of the present disclosure, a cutting insert has mirror image symmetry based on a first symmetry plane orthogonal to a central axis of a mounting hole, and further has mirror image symmetry based on a second symmetry plane including the central axis. The cutting insert includes a front surface, a back surface opposite to the front surface, a peripheral side surface connecting between the front surface and the back surface, and a mounting hole penetrating the front surface and the back surface. The peripheral side surface is formed parallel to the central axis. The peripheral side surface includes a first cutting part including a first cutting edge parallel to the central axis, and a first rake face and a first flank adjoining the first cutting edge, a second cutting part having a mirror image symmetry with respect to the first cutting part based on the second symmetry plane, and including a second cutting edge parallel to the central axis, and a second rake face and a second flank adjoining the second cutting edge, a base end portion on a side opposite to a tip portion provided with the first cutting part and the second cutting part, a first flat plane connecting between a third flat plane contiguous with the first rake face and one end of the base end portion, a fourth flat plane having a mirror image symmetry with respect to the third flat plane based on the second symmetry plane and being contiguous with the second rake face, and a second flat plane having a mirror image symmetry with respect to the first flat plane based on the second symmetry plane, and connecting between the fourth flat plane and the other end of the base end portion. The first flank includes a ridge line of the first cutting edge and has a positive clearance angle with respect to a third reference plane orthogonal to the second flat plane or a virtual plane extending the second flat plane.

According to this aspect, since there is a third flat plane between the first flat plane and the first rake face, when the second flat plane is arranged parallel to the longitudinal direction of the turning tool, the cutting insert can be configured such that the first flank has a positive clearance angle with respect to the third reference plane perpendicular to the second flat plane without making the wedge angle of the first cutting part extremely small. Even when the second flat plane is arranged parallel to the longitudinal direction of the turning tool, it can be established as a turning tool for grooving and projecting purposes. When the second flat plane can be arranged parallel to the longitudinal direction of the turning tool, the distance from the tip of the tool body that receives the main component force of the cutting resistance, to the ridge line of the cutting edge of the first cutting part can be made shorter as compared with the case where the second symmetry plane, which is the mirror image symmetry plane of the first flat plane and the second flat plane, is arranged parallel to the longitudinal direction of the turning tool. Furthermore, since the second flat plane is orthogonal, rather than diagonally, to a direction in which the main component force of the cutting resistance is applied, the cutting resistance can be more reliably received on the insert mounting seat that comes into contact with the second flat plane. A turning tool with excellent rigidity can be formed. Since the cutting insert is not likely to protrude from the tool body in the direction in which the turning tools are arranged adjacent to each other, it is possible to construct a turning tool that is not likely to interfere with other tools.

In the aspect described above, the third flat plane may be formed parallel to the second flat plane. The fourth flat plane, which has a mirror image symmetry with respect to the third flat plane based on the second symmetry plane, may be formed parallel to the first flat plane.

According to this aspect, when the second flat plane is arranged so as to be parallel to the longitudinal direction of the turning tool, the width between the second flat plane and the third flat plane does not increase in the direction in which the turning tools are arranged adjacent to each other. Likewise, when the front and back sides of the cutting insert are reversed and the first flat plane is arranged so as to be parallel to the longitudinal direction of the turning tool, the width of the first flat plane and the fourth flat plane does not increase in the direction in which the turning tools are arranged adjacent to each other. The turning tool can be configured such that a protrusion amount of the cutting insert from the tool body is minimized in the direction in which the turning tools are arranged adjacent to each other.

In the aspect described above, the distance to the central axis from the line of intersection where the virtual plane extending from the first flat plane and the virtual plane extending from the second flat plane intersect each other may be longer than the distance from the ridge line of the first cutting edge to the central axis.

According to this aspect, since the distance between the tightening screw for fixing the cutting insert and the first and the second cutting parts where the main component force of the cutting resistance is applied is short, the rigidity of the turning tool including the cutting insert is improved.

In the aspect described above, the front surface and the back surface are divided into a thick-walled region in which the mounting hole is arranged, and a thin-walled region in which a plate thickness between the front surface and the back surface is smaller than that of the thick-walled region. Both the first flat plane and the second flat plane may be formed so as to span a portion where the peripheral side surface is adjoined with the thick-walled region and a portion where the peripheral side surface is adjoined with the thin-walled region.

According to this aspect, the plate thickness of the thin-walled region can be changed, so that the blade widths of the first and second cutting edges can be freely designed. Since the first and second flat planes extend to the thin-walled region where the first and second cutting parts are formed, the insert mounting seat that comes into contact with the second flat plane in the tool body paired with the cutting insert can be arranged up to immediately below the first and second cutting parts.

In the aspect described above, the third reference plane may intersect the second plane or may intersect the virtual plane extending from the second flat plane. When the third reference plane does not intersect the second plane, the line of intersection where the third reference plane and the virtual plane extending from the second flat plane intersect may have the distance from the tip of the second flat plane equal to or less than the blade width of the first cutting edge.

According to this aspect, even when the line of intersection with the area directly below the first cutting edge, that is, the third reference plane, is not on the second flat plane, since the distance between the cutting edge of the first cutting part and the tip of the second flat plane supported by the insert mounting seat in the longitudinal direction of the tool body is extremely small, the turning tool including cutting inserts can receive the main component force of cutting resistance almost directly below. The rigidity of the turning tool is improved.

According to the present disclosure, it is possible to provide a cutting insert, in which it is possible to form a turning tool that is not likely to interfere with other tools and has excellent rigidity.

### BRIEF DESCRIPTION OF THE DRAWINGS

For a better understanding of the present invention and to show how the same may be carried out in practice, reference will now be made to the accompanying drawings, in which:

FIG. 1 is a perspective view illustrating an example of a turning tool provided with a cutting insert according to an embodiment of the present disclosure.

FIG. 2 is a perspective view illustrating an example of a cutting insert according to an embodiment of the present disclosure.

FIG. 3 is a perspective view illustrating the peripheral side surface illustrated in FIG. 2 when viewed from a different angle.

FIG. 4 is a front view illustrating a rake angle and a clearance angle of the first and second cutting parts.

FIG. 5 is a front view illustrating a turning tool attached with a cutting insert according to the present embodiment, when viewed from a direction parallel to a rotation axis of a spindle of a machine tool.

FIG. 6A is a perspective view of a cutting insert according to another embodiment of the present invention;

FIG. 6B is a view of the cutting insert of FIG. 6A taken perpendicular to the front surface of the cutting insert;

FIG. 6C is a forward view of the cutting insert of FIG. 6A;

FIG. 7A is a perspective view of a cutting tool according to another embodiment of the present invention;

FIG. 7B is a view of the cutting tool of FIG. 7A taken perpendicular to the front surface of the cutting insert; and

FIG. 8 is an exploded view of the cutting tool of FIG. 7A.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

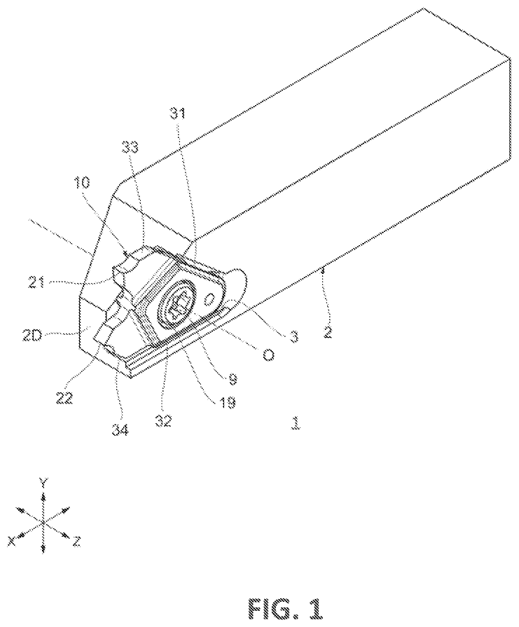

Preferred embodiments of the present disclosure will be described with reference to the accompanying drawings. In each drawing, those having the same reference numerals have the same or similar configurations. First, some configurations will be described in detail with reference to FIGS. 1 to 5. FIG. 1 is a perspective view illustrating an example of a turning tool 1 provided with a cutting insert 10 according to an embodiment of the present disclosure. The cutting insert 10 according to an embodiment of the present disclosure is a cutting insert suitable for the turning tool 1 which is attached to a comb-shaped tool post (e.g., Swiss tool, gang tool), or the like, of a machine tool and is used for the purposes of grooving or cutting off.

As illustrated in FIG. 1, the turning tool 1, which is a cutting edge replaceable type, includes the replaceable cutting insert 10 and a tool body 2 for fixing the cutting insert 10, and is fixed to a tool post or the like to be used. When a plurality of turning tools including the turning tool 1 are attached to the comb-shaped tool post of the machine tool to be used, the turning tools are arranged in parallel so as to be adjacent to each other in the Y-axis direction in FIG. 1. From the viewpoint of the operator, the X-axis direction, which is the longitudinal direction of the tool body 2, coincides with the up-and-down direction, for example, and the Y-axis direction, which is the direction in which the turning tools 1 are adjacent to each other, coincides with the front-and-back direction, for example, and the Z-axis direction, which is parallel to the rotation axis of the workpiece, coincides with the left-and-right direction, for example.

An insert mounting seat 3 recessed in a shape similar to the cutting insert 10 is provided at a tip portion that includes a tip 2D of the tool body 2 and a portion in the vicinity of the tip. The cutting insert 10 is fixed to the insert mounting seat 3 so that a central axis O of a mounting hole 19 is in the Z-axis direction and either one of a second flat plane 32 and a first flat plane 31, which will be described below, is parallel to the X-Z plane by a tightening screw 9 or the like.

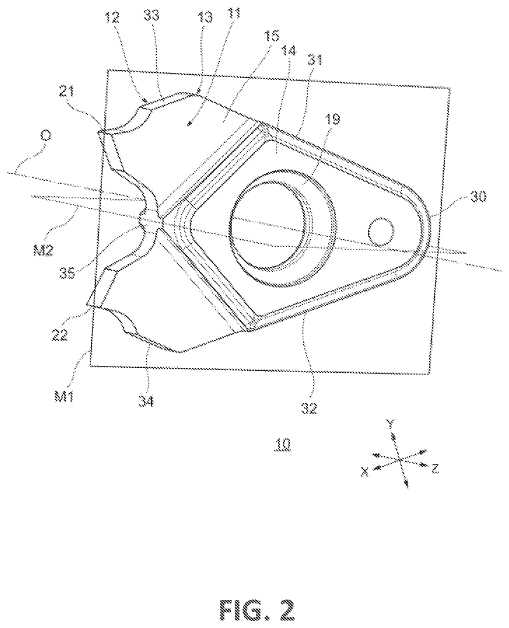

FIG. 2 is a perspective view illustrating an example of the cutting insert 10 according to an embodiment of the present disclosure. The material of the cutting insert 10 is not particularly limited, and various materials for cutting inserts such as cemented carbide can be applied. As illustrated in FIG. 2, the cutting insert 10 includes a front surface 11 (first main surface), a back surface 12 (second main surface) opposite to the front surface 11, a peripheral side surface 13 connecting between the front surface 11 and the back surface 12, the mounting hole 19 penetrating the front surface 11, the back surface 12, and first and second cutting parts 21 and 22 formed on the peripheral side surface 13. The first cutting part 21 is used with the back surface 12 being on the insert mounting seat 3 side, and the second cutting part 22 is used with the front and back surfaces being inverted such that the front surface 11 is on the insert mounting seat 3 side.

As illustrated in FIG. 2, the cutting insert 10 has mirror image symmetry based on a first symmetry plane M1 orthogonal to the central axis O of the mounting hole 19, and further has mirror image symmetry based on a second symmetry plane M2 including the central axis O. The first symmetry plane M1 is parallel to the X-Y plane and is located equidistant from the front surface 11 and the back surface 12, and bisects the plate thickness of the cutting insert 10. The second symmetry plane M2 is orthogonal to the X-Y plane and intersects the Y-Z plane so as to form 20°, for example, and is located equidistant from the first and second cutting parts 21 and 22, and bisects the front surface 11 and the back surface 12.

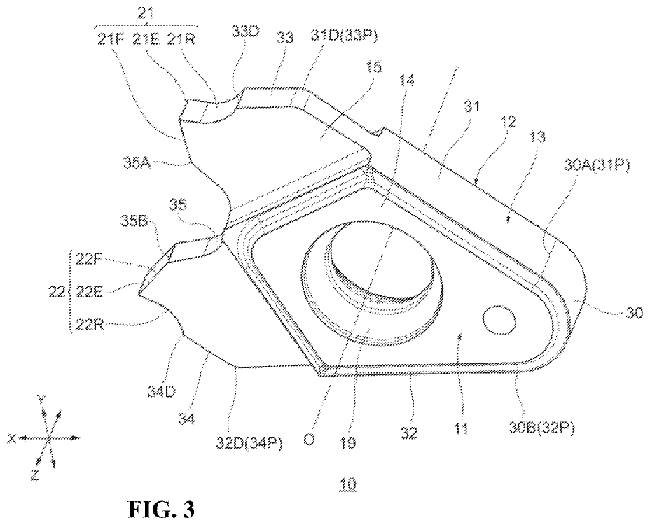

FIG. 3 is a perspective view illustrating the peripheral side surface 13 illustrated in FIG. 2 when viewed from a different angle. As illustrated in FIG. 3, the peripheral side surface 13 of the cutting insert 10 is formed parallel to the central axis O. The peripheral side surface 13 further includes, in addition to the first and second cutting parts 21 and 22 described above, a base end portion 30 opposite to tip portions (21, 22) on which the first and second cutting parts 21 and 22 are formed, the first and third flat planes 31 and 33 connecting between the base end portion 30 and the first cutting part 21, the second and fourth flat planes 32 and 34 connecting between the base end portion 30 and the second cutting part 22, and a connection surface 35 connecting between the first cutting part 21 and the second cutting part 22.

Each of the first to fourth flat planes 31, 32, 33, and 34 includes a base end close to the base end portion 30, and a tip close to the tip portion (21, 22), and is formed in a flat plane from the base end to the tip. The base end portion 30 is formed on a part of a cylindrical surface and includes one end 30A and the other end 30B on the opposite side to the one end. The connection surface 35 is formed on a curved surface recessed on the base end portion 30 side, and has one end 35A and the other end 35B on the opposite side to the one end.

The first cutting part 21 includes a first cutting edge 21E parallel to the central axis O, and a first rake face 21R and a first flank 21F adjoining the first cutting edge 21E. Likewise, the second cutting part 22 includes a second cutting edge 22E parallel to the central axis O, and a second rake face 22R and a second flank 22F adjoining the second cutting edge 22E. A ridge line where the first rake face 21R and the first flank 21F intersect each other is the first cutting edge 21E, and a ridge line where the second rake face 22R and the second flank 22F intersect each other is the second cutting edge 22E.

A tip 33D of a third flat plane 33 is contiguous with the first rake face 21R of the first cutting part 21. The first flat plane 31 connects between a base end 33P of the third flat plane 33 and the one end 30A of the base end portion 30. Likewise, a tip 34D of the fourth flat plane 34 is contiguous with the second rake face 22R of the second cutting part 22. The second flat plane 32 connects between a base end 34P of the fourth flat plane 34 and the other end 30B of the base end portion 30.

When R chamfering or C chamfering is performed at a boundary portion between the first flat plane 31 and the third flat plane 33, the position of a tip 31D of the first flat plane 31 and the base end 33P of the third flat plane 33 is an intermediate position between a start point and an end point where the curvature of the R chamfer changes, and is an intermediate position between one ridge line and the other ridge line of the C chamfer. Likewise, the position of a tip 32D of the second flat plane 32 and the base end 34P of the fourth flat plane 34 is an intermediate position of the machined surface chamfered by R chamfering or C chamfering.

The front surface 11 and the back surface 12 are divided into a thick-walled region 14 having a large plate thickness between the front surface 11 and the back surface 12, and a thin-walled region having a smaller plate thickness than the thick-walled region 14. The mounting hole 19 is formed in the thick-walled region 14. The first and second cutting parts 21 and 22 are formed in a thin-walled region 15. Each of first and second flat planes 31 and 32 is formed so as to span a portion where the peripheral side surface 13 is adjoined with the thick-walled region 14 and a portion where the peripheral side surface 13 is adjoined with the thin-walled region 15.

The front surface 11 and the back surface 12 have mirror image symmetry based on the first symmetry plane M1 (illustrated in FIG. 2) described above. Each of the first cutting edge 21E, the first rake face 21R, and the first flank 21F forming the first cutting part 21, and each of the second cutting edge 22E, the second rake face 22R and the second flank 22F forming the second cutting part 22 have mirror image symmetry based on the second symmetry plane M2 (illustrated in FIG. 2) described above. Likewise, the first and second flat planes 31 and 32 have mirror image symmetry based on the second symmetry plane M2, and the third and fourth flat planes 33 and 34 have mirror image symmetry based on the second symmetry plane M2.

That is, each of the back surface 12, the second cutting part 22, and the second and fourth flat planes 32 and 34 has substantially the same shape and function as each of the front surface 11, the first cutting part 21, and the first and third flat planes 31 and 33. Therefore, the first cutting part 21, and the first and third flat planes 31 and 33 will be described in detail as a representative example, and the descriptions of the second cutting part 22, and the second and fourth flat planes 32 and 34 overlapping with those previously described may be omitted.

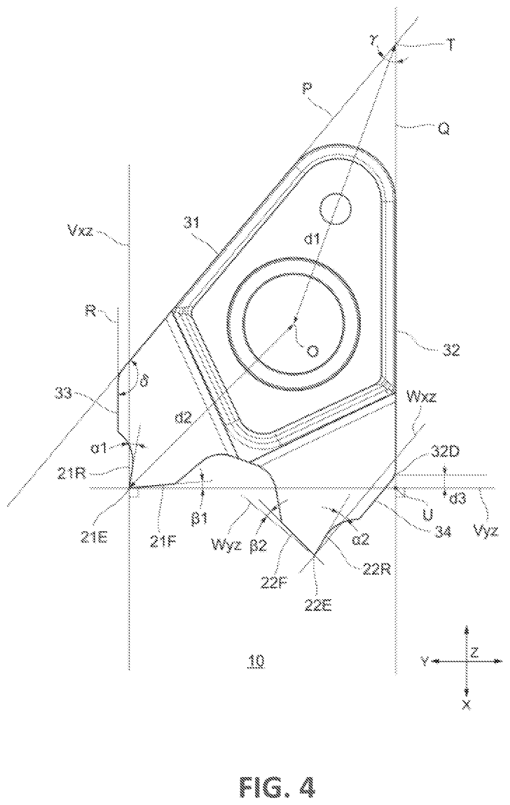

FIG. 4 is a front view illustrating rake angles α1 and α2 and clearance angles β1 and β2 of the first and second cutting parts 21 and 22. One of the features of the cutting insert 10 according to the present embodiment is that one of the second flat plane 32 and the first flat plane 31 is configured to be parallel to the longitudinal direction X of the tool body 2 instead of the second symmetry plane M2. As illustrated in FIG. 4, the first rake face 21R includes the ridge line of the first cutting edge 21E, that is, the ridge line where the first rake face 21R and the first flank 21F intersect each other, and has the positive rake angle α1 with respect to a first reference plane Vxz parallel to the second flat plane 32. In addition, the first flank 21F includes the ridge line of the first cutting edge 21E, that is, the ridge line where the first rake face 21R and the first flank 21F intersect each other, and has the positive clearance angle β1 with respect to the second flat plane 32 or a third reference plane Vyx orthogonal to a virtual plane Q (second virtual plane) extending from the second flat plane 32.

Likewise, the second rake face 22R, which has mirror image symmetry with the first rake face 21R based on the second symmetry plane M2, includes the ridge line of the second cutting edge 22E, that is, the ridge line where the second rake face 22R and the second flank 22F intersect each other, and has the positive rake angle α2 with respect to a second reference plane Wxz parallel to the first flat plane 31. The second flank 22F, which has mirror image symmetry with respect to the first flank 21F based on the second symmetry plane M2, includes the ridge line of the second cutting edge 22E, that is, the ridge line where the second rake face 22R and the second flank 22F intersect each other, and has the positive clearance angle β2 with respect to the first flat plane 31 or a fourth reference plane Wyz orthogonal to a virtual plane P (first virtual plane) extending from the first flat plane 31.

The virtual plane P and the virtual plane Q intersect at an intersection angle γ of about 30 to 45°. In the illustrated example, the intersection angle γ is 40°. A distance d1 from a line of intersection T where the virtual planes P and Q intersect each other, to the central axis O of the mounting hole 19 is greater than a distance d2 from the ridge line of the first cutting edge 21E of the first cutting part 21 to the central axis. Since the distance d2 between the tightening screw 9 (illustrated in FIG. 1) for fixing the cutting insert 10 and the first cutting part 21 and the second cutting part 22 where the main component force of the cutting resistance is applied is short, the turning tool 1 has excellent rigidity.

The third reference plane Vyz described above is orthogonal to the second flat plane 32 or its virtual plane Q at a line of intersection U. The line of intersection U is located directly below the first cutting part 21 where the main component force of the cutting resistance is applied. In the cutting insert 10 according to the present embodiment, whether the line of intersection U is located on the second flat plane 32 or is not located on the second flat plane 32, a distance d3 between the line of intersection U and the tip 32D of the second flat plane 32 is much smaller than the background techniques described in PTL 1 to PTL 3. Preferably, the line of intersection U is located on the second flat plane 32. When the line of intersection U is not located on the second flat plane 32, the distance d3 is about half the blade width of the first cutting edge 21E (the plate thickness of the thin-walled region 15), for example, and is at least equal to or less than the blade width of the first cutting edge 21E.

In the illustrated example, the third flat plane 33 is formed parallel to the second flat plane 32, and the fourth flat plane 34 is formed parallel to the first flat plane 31. In other words, an intersection angle δ at which the virtual plane P described above and a virtual plane R (third virtual plane) extending from the third flat plane 33 intersect each other is a complementary angle (180°-γ) of the intersection angle γ. Likewise, the virtual plane Q described above and a virtual plane (not illustrated) extending from a fourth plane 34 intersect each other at a complementary angle of the intersection angle γ.

However, as long as the first flank has the positive clearance angle β1 and a wedge angle (90°-α1-β1) of the cutting edge of the first cutting part 21 is not extremely small, the third flat plane 33 may be slightly inclined so as to approach the second flat plane 32 toward the base end portion 30 side. The fourth flat plane 34, which has mirror image symmetry with respect to the third flat plane 33 based on the second symmetry plane M2, may also be slightly inclined so as to approach the first flat plane 31 toward the base end portion 30 side. When the intersection angle γ of the virtual planes P and Q is around 40°, the intersection angle δ of the virtual planes P and R is 100° or more and 160° or less, for example.

With the cutting insert 10 according to the present embodiment configured as described above, the third and fourth flat planes 33 and 34 having the intersection angle δ with respect to the first and second flat planes 31 and 32 are formed, so that either one of the second flat plane 32 and the first flat plane 31 can be arranged so as to be parallel to the longitudinal direction X of the tool body 2, instead of the second symmetry plane M2.

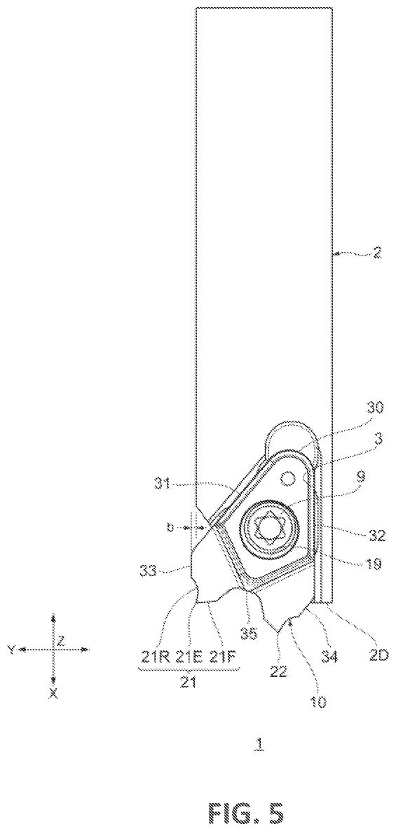

FIG. 5 is a front view illustrating the turning tool 1 attached with the cutting insert according to the present embodiment, when viewed from the Z-axis direction parallel to the rotation axis of the spindle of the machine tool, that is, the rotation axis of the work material. As illustrated in FIG. 5, in a state that the cutting insert 10 is fixed to the tool body 2, with the second flat plane 32 arranged parallel to the longitudinal direction X of the tool body 2, and without having an extremely small wedge angle (90°-α1-β1) of the cutting edge of the first cutting part 21, the turning tool 1 having the positive clearance angle β1 can be configured. Therefore, the turning tool 1 provided with the cutting insert 10 can be used as a turning tool for the purposes of grooving and projecting.

As illustrated in FIG. 4, as compared with the case where the second symmetry plane M2 is arranged so as to be parallel to the longitudinal direction X of the tool body 2, since the distance d3 between the cutting edge of the first cutting edge 21E and the tip 32D of the second flat plane 32 supported by the insert mounting seat 3 can be shortened, the turning tool 1 having improved rigidity can be configured. As illustrated in FIG. 5, since the third flat plane 33 is formed parallel to, or substantially parallel to the second flat plane 32, a protrusion amount b of the cutting insert 10 from a shank portion of the tool body 2 in the Y-axis direction in which the turning tools 1 are adjacent to each other can be reduced. Therefore, the turning tool 1 that does not easily interfere with other tools can be configured.

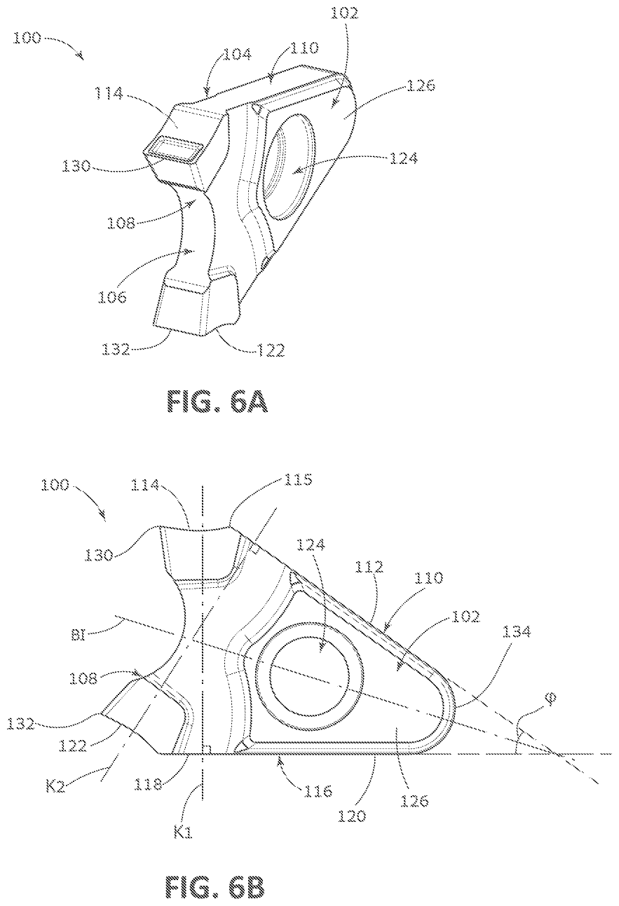

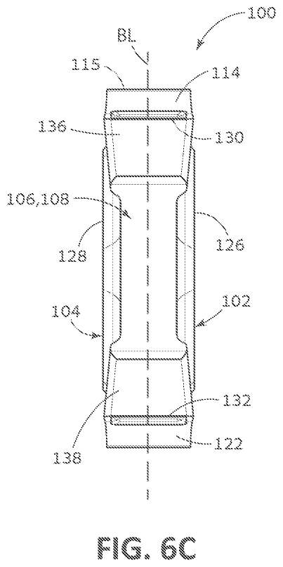

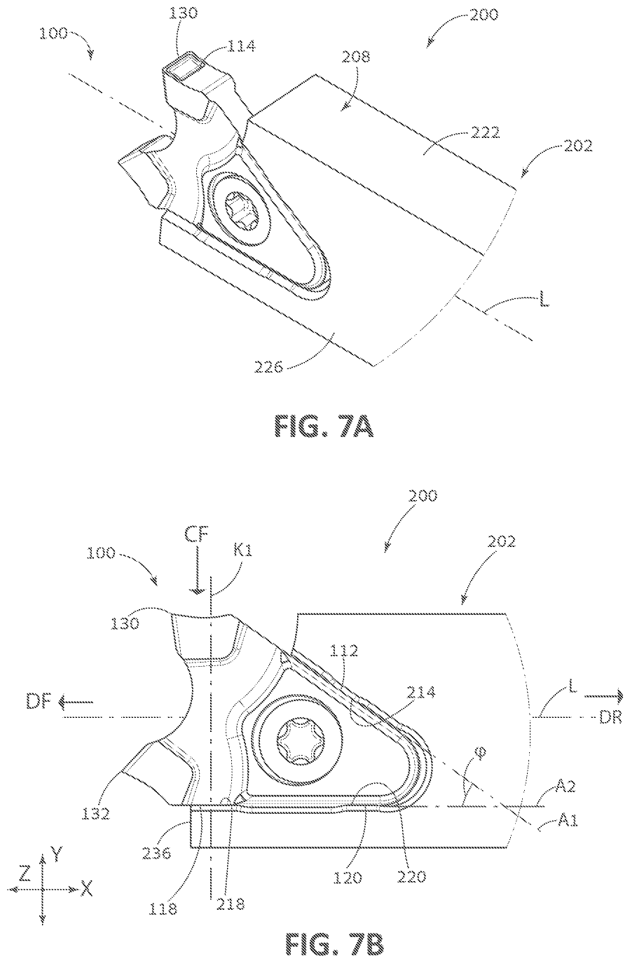

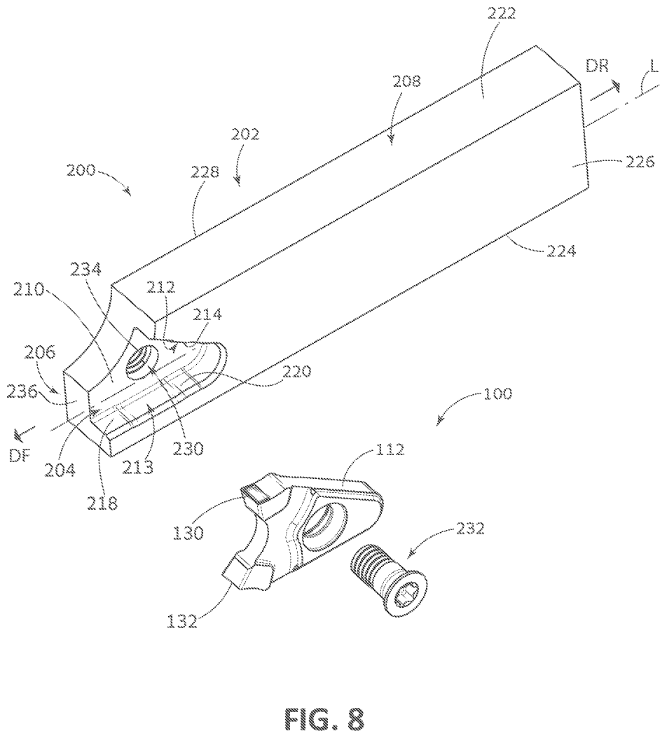

Reference is now made to FIGS. 6A, 6B, 6C, 7A, 7B and 8, which depict various views of a cutting insert 100 and a cutting tool 200, according to other embodiments of the present invention. FIG. 6A is a perspective view of a double sided V-shaped cutting insert 100, and FIG. 6B is a view of the cutting insert of FIG. 6A. FIG. 6C is a forward view of the cutting insert of FIG. 6A. FIG. 7A is perspective view of a cutting tool 200, and FIG. 7B is a view of the cutting insert of FIG. 7A. FIG. 8 is a perspective exploded view of the cutting tool of FIG. 7A.

The cutting tool 200 is used for metal cutting operations, and in particular turn grooving and/or parting. The cutting insert 100 is typically made of extremely hard and wear-resistant material such as cemented carbide, which is made, for example, by form-pressing and sintering carbide powders in a binder, or by powder injection molding methods. However, the material of the cutting insert 100 is not particularly limited, and various materials suitable for cutting inserts may be applied.

With reference to FIGS. 6A, 6B and 6C, the double sided V-shaped cutting insert 100 includes an insert front surface 102, and an opposite insert back surface 104. A peripheral surface 106 extends between the insert front and back surfaces 102, 104.

The peripheral surface 106 further includes a forward surface 108, and a first converging surface 110, which is a planar surface. The peripheral surface 106 also includes a first rake surface 114 extending between the forward surface 108 and the first converging surface 110. The peripheral surface 106 further includes a second converging surface 116, which is a planar surface. The second converging surface 116 forms a convergence angle φ with the first converging surface 110.

The peripheral surface 106 also includes a second rake surface 122 extending between the forward surface 108 and the second converging surface 116.

A bisector plane BI of the convergence angle φ is defined between, and equally distanced from, each of the first rake surface 114 and the second rake surface 122. The first rake surface 114 and the second rake surface 122 each face away in opposite directions relative to the bisector plane BI. The cutting insert 100 exhibits mirror symmetry about the bisector plane BI, at least in a view taken perpendicular to the insert front surface 102.

The first rake surface 114 tends towards the bisector plane BI more than the first converging surface 110. The second rake surface 122 tends towards the bisector plane BI more than the second converging surface 112.

The first rake surface 114 and the first converging surface 110 intersect at an intersection portion 115. Such that the intersection portion 115 forms a “bending portion” between the first rake surface 114 and the first converging surface 110, relative to the bisector plane BI. Due to the mirror symmetry of the cutting insert 100 about the bisector plane BI, the same applies for the intersection between the second rake surface 122 and the second converging surface 112.

The convergence angle φ is in the range of 30°-45°. According to some embodiments, the convergence angle φ is equal to, or larger than 35°, such that: φ≥35°. In a particular embodiment, the convergence angle φ is equal to 40°, such that: φ=40°.

The cutting insert 100 may be referred to as “V-shaped” due to the converging V-shape formed by the first converging surface 110 and the second converging surface 116. The first converging surface 110 and the second converging surface 116 are connected by an insert rear surface 134.

In some embodiments, the insert rear surface 134 may be constructed as a curved surface, as depicted for example in FIG. 6B. In particular, the insert rear surface 134 may be constructed as a portion of a circular curve.

In other embodiments, the insert rear surface 134 may be constructed as a single planar surface (not shown) or a series of planar surfaces (not shown), which connect between first converging surface 110 and the second converging surface 116.

In some embodiments, the insert front surface 102 includes a planar first support surface 126, and the insert back surface 104 includes a planar second support surface 128. The first support surface 126 extends parallel to the second support surface 128.

With further reference to FIG. 6B, which is a view taken perpendicular to the insert front surface 102 (e.g., perpendicular to first support surface 126), a first line K1, which passes through the first rake surface 114 and extends perpendicular to the second converging surface 116, also passes through the second converging surface 116.

Similarly, in the view of FIG. 6B, which is taken perpendicular to the insert front surface 102 (e.g., perpendicular to first support surface 126), a second line K2 passes through the second rake surface 122 and extends perpendicular to the first converging surface 110, also passes through the first converging surface 110. It should be noted, that the same would be applicable in a view (not shown) taken perpendicular to the insert back surface 104 (e.g., perpendicular to first support surface 128).

In some embodiments, the first converging surface 110 has a first abutment portion 112 located thereon. The second converging surface 116 has coplanar second and third abutment portions 118, 120 located thereon. The second and third abutment portions 118, 120 are spaced apart from one another, such that the second abutment portion 118 is located closer to the forward surface 108 than the third abutment portion 120. The first line K1 also passes through the second abutment portion 118 and extends perpendicular thereto.

With further reference to FIG. 6C, the cutting insert 100 also exhibits mirror symmetry about a insert central longitudinal plane BL, which passes equidistantly between the insert front and back surfaces 102, 104.

It would be appreciated that the cutting insert has a symmetry axis (not shown) included in the bisector plane BI and also in the central longitudinal plane BL (i.e., passing through the middle of the cutting insert 100). When the cutting insert 100 is rotated by 180° about this symmetry axis, it reaches the same position as before being rotated. That is, after such rotation, the first rake surface 114 and the second rake surface 122 would change places. In this case, the second and third abutment portions 118, 120 would be located on the first converging surface 110, and the first abutment portion 112 would be located on the second converging surface 116.

In some embodiments of the present invention, the first support surface 126 and the second support surface 128, are spaced apart from the forward surface 108 of the cutting insert 100. Alternatively, the first support surface 126 and the second support surface 128 may extend adjacent to the forward surface 108.

In some embodiments of the present invention, the cutting insert 100 further has a through bore 124 extending transversely to the insert front and back surfaces 102, 104. The through bore 124 opens out to the insert front and back surfaces 102, 104, and is intended to receive a fastening member when the cutting insert 100 is attached to a cutting tool, as will be discussed herein.

In some embodiments, the through bore 124 opens out to the first support surface 126 and to the second support surface 128. That is, openings of the through bore 124 are surrounded by the first support surface 126 and the second support surface 128.

In some embodiments, the forward surface 108 and the first rake surface 114 of the cutting insert 100, intersect at a first cutting edge 130. Similarly, the forward surface 108 and the second rake surface 122 intersect at a second cutting edge 132.

In some embodiments, the forward surface 108 includes a first relief surface 136, extending from the first cutting edge 130 along the forward surface 108. The forward surface 108 then also includes a second relief surface 138, extending from the second cutting edge 132 along the forward surface 108.

With particular reference to FIGS. 7A, 7B and 8, showing the cutting tool 200, according to an embodiment of the present invention. The cutting tool 200 includes the cutting insert 100 as described above with reference to FIGS. 6A, 6B and 6C, and a tool holder 202. The tool holder 202 extends along a longitudinal axis L, which defines a forward direction DF and an opposite rearward direction DR.

The tool holder 202 includes an insert seat 204 located at a forward end 206 of the tool holder 202, and a shank portion 208 extending from the insert seat 204 in the rearward direction DR.

The insert seat 204 includes a seat support surface 210, and a first seat converging wall 212, which extends transversely to the seat support surface 210. The first seat converging wall 212 has a planar first seat abutment portion 214 located thereon. The first seat abutment portion 214 may extend transversely to the insert seat support surface 210.

The insert seat 204 further includes a second seat converging wall 213, which also extends transversely to the seat support surface 210. The second seat converging wall 213 has a planar second seat abutment portion 218 and a planar third seat abutment portion 220, located thereon. The second and third seat abutment portions 218, 220 are coplanar and spaced apart from one another. The second and third seat abutment portions 218, 220 extend parallel to the longitudinal axis L. The second seat abutment portion 218 is located forwardly of the third seat abutment portion 220, along the longitudinal axis L.

In some embodiments, the second and third seat abutment portions 218, 220 may extend transversely to the seat support surface 210.

With further reference to FIG. 7B, a first plane A1 is indicated, which includes the first seat abutment portion 214, and a second plane A2 is indicated, which includes the second and third seat abutment portions 218, 220. The first and second planes A1, A2 converge in the rearward direction DR, forming the convergence angle φ therebetween, similarly to the convergence of the first and second converging surfaces 110, 116 of the cutting insert 100.

The cutting insert 100 is placed in the insert seat 204, such that the first insert abutment portion 112 abuts the first seat abutment portion 214, the second and third insert abutment portions 118, 120 abut the second and third seat abutment portions 218, 220, respectively, and the insert back surface 104 abuts the seat support surface 210. In particular, the second support surface 128 of the insert back surface 104, abuts the seat support surface 210. Such positioning provides that the cutting insert 100 has a firm three-point abutment with the insert seat 204, through the first, second and third seat abutment portions 214, 218, and 220.

As mentioned above, the convergence angle φ is in the range of 30°-45°. According to some embodiments, the convergence angle φ is equal to, or larger than 35°, such that: φ≥35°. Such values of the convergence angle φ provide a firm locking position for the cutting insert 100 in the insert seat 204, to provide support for the cutting insert 100 against forces acting thereon during metal cutting, as will be further elaborated herein below. Such forces may urge the cutting insert 100 to be pulled out of the insert seat 204, or move in the lateral direction.

In some embodiments, the tool holder 202 further includes a fastening bore 230 which extends transversely to the longitudinal axis L, and opens out to the seat support surface 210. The cutting insert 100 is then attached to the insert seat 204 by a fastening member 232, which passes through the through bore 124 of the cutting insert 100, and engages with the fastening bore 230 of the tool holder 202. The fastening member 232 may be, for example, a fastening screw, which threadedly engages with a threaded portion 234 in the fastening bore 230 of the tool holder 202.

In some embodiments, the tool holder 202 further includes a holder top surface 222, a holder bottom surface 224 parallel to the holder top surface 222, a holder front surface 226, and a holder back surface 228. The holder front surface 226 and the holder back surface 228 extend between the holder top surface 222 and the holder bottom surface 224. The holder front surface 226, the holder back surface 228, the holder top surface 222 and the holder bottom surface 224, extend along the longitudinal axis L.

In some embodiments, the second and third seat abutment portions 218, 220 may extend parallel to the holder bottom surface 224.

In some embodiments, the shank portion 208 has a rectangular cross section, such that the holder front surface 226 is parallel to the holder back surface 228, and the holder top surface 222 is parallel to the holder bottom surface 224, and the holder top surface 222 is perpendicular to the holder front surface 226.

In some embodiments, the tool holder 202 further includes a holder forward surface 236 located at the forward end 206 of the tool holder 202. The holder forward surface 236 extends transversely to the longitudinal axis L, between the holder forward surface 226, the holder back surface 228, the holder top surface 222 and the holder bottom surface 224. The holder forward surface 236 intersects the second seat abutment portion 218.

In FIG. 7B, a system of axes is indicated, to show the directions of X, Y and Z axes (similarly to the axes shown in FIGS. 1-5). When the cutting insert 100 is attached to the tool holder 202, the first cutting edge 130 of the cutting insert 100 is positioned so as to be ready for cutting metal chips off a workpiece (not shown). A cutting force CF which operates on the cutting insert 100 during machining (e.g., grooving), is directed substantially along the Y-axis direction. In this position, the cutting edge 130 is an active cutting edge, which the cutting edge 132 is an inactive cutting edge.

As mentioned above, the first line K1 of the cutting insert 100 passes through the second abutment portion 118 and extends perpendicular thereto. Therefore, when the cutting insert 100 is attached to the tool holder 202, the first line K1 of the cutting insert 100 also passes through the second seat abutment portions 218, and extends perpendicular thereto. It would be appreciated that the first line K1 extends substantially parallel to the Y-axis direction, as shown in FIG. 7B. Thus, the second seat abutment portions 218 provides support for the cutting insert 100, substantially directly under the first rake surface 114, and countering the cutting force CF.

When the cutting tool 200 is operative in a grooving application against a workpiece (not shown), the cutting force CF is directed at the cutting edge 130, substantially along the relief surface 136. In a view taken perpendicular to the insert front surface 102, an imaginary line (not shown), which extends along the relief surface 136, would extend to intersect the second insert abutment portion 118. Thus, also in this case, the second seat abutment portions 218 provides support for the cutting insert 100, countering the cutting force CF (or at least the main components thereof).

It would be appreciated that such support for the cutting insert 100, during cutting operation of the cutting edge 130, is a desired factor, since it provides greater stability and prolongs the tool life of the cutting insert 100 and the cutting tool 200. This provides a significant advantage to the cutting insert 100 and the cutting tool 200, relative to other tools known in the art, which do not have such support structure.

The cutting force CF may have an additional or partial component in the direction of the X axis, in the rearward direction DR. In this case, the X axis component will act to push the cutting insert 100 into the insert seat 204. Due to the V-shape structure of the cutting insert 100, it will be wedged into the insert pocket 204, and secured in a more rigid manner to the abutment surfaces of the insert seat 204. It has been found that with the value of the convergence angle φ being in the range of 30°-45°, the above mentioned wedging effect is at its best, better securing the cutting insert 100 into the insert seat 204.

It would be further appreciated that the embodiment described above with reference to FIGS. 1-5 differs from the embodiment described above with reference to FIGS. 6A-8, mainly in that it includes the flat planes 33 and 34, each of them located between the respective rake surface and the respective flat support surface. As noted above, the third flat plane 33 may be slightly inclined so as to approach the second flat plane 32. In the specific case when the third flat plane 33 is sufficiently inclined, until it practically unites with the respective flat plane 31, then the embodiment of FIGS. 6A-6C is achieved. In other words, the embodiment of FIGS. 6A-6C is a specific case of the embodiment of FIGS. 1-5.

It is noted that the embodiments described above are provided for facilitating the understanding of the present disclosure, and are not to be construed as limiting the interpretation of the present disclosure. In addition, each element included in the embodiments and its arrangement, material, condition, shape, size, and the like are not limited to those exemplified, and can be changed as appropriate. Further, the configurations illustrated in different embodiments can be partially replaced or combined.

1.-19. (canceled)

20. A double sided V-shaped cutting insert, comprising:
an insert front surface;
an insert back surface; and
a peripheral surface extending between the insert front and back surfaces, the peripheral surface comprising:
a forward surface;
a planar first converging surface;
a first rake surface extending between the forward surface and the planar first converging surface;
a planar second converging surface forming a convergence angle (q) with the first converging surface, fulfilling the condition: 30°≤φ≤45°; and
a second rake surface extending between the forward surface and the second converging surface;
wherein:
a bisector plane (BI) of the convergence angle (φ) is defined between, and equally distanced from, each of the first rake surface and the second rake surface, and the cutting insert exhibits mirror symmetry about the bisector plane (BI), at least in a view taken perpendicular to the insert front surface;
the first rake surface and the second rake surface each face away from the bisector plane; and
the first rake surface tends towards the bisector plane (BI) more than the first converging surface, and the second rake surface tends towards the bisector plane (BI) more than the second converging surface.

21. The double sided V-shaped cutting insert, according to claim 20, wherein:
the first converging surface has a first insert abutment portion located thereon;
the second converging surface has coplanar second and third insert abutment portions located thereon, the second and third insert abutment portions being spaced apart from one another, and
the second insert abutment portion is located closer to the forward surface than the third insert abutment portion.

22. The double sided V-shaped cutting insert according to claim 20, wherein
in a view taken perpendicular to one of the insert front and back surfaces, a first line (K1) passing through the first rake surface and extending perpendicular to the second insert abutment portion, also passes through the second insert abutment portion.

23. The double sided V-shaped cutting insert according to claim 20, wherein:
the convergence angle (φ) is equal to, or larger than 35°, such that φ≥35°.

24. The double sided V-shaped cutting insert according to claim 20, wherein:
the insert front surface comprises a planar first support surface;
the insert back surface comprises a planar second support surface; and
the first support surface is parallel to the second support surface.

25. The double sided V-shaped cutting insert according to claim 20, further comprising:
a through bore extending transversely to the insert front and back surfaces and opening out to the insert front and back surfaces.

26. The double sided V-shaped cutting insert according to claim 24, wherein:
the through bore opens out to the first support surface and to the second support surface.

27. The double sided V-shaped cutting insert according to claim 20, wherein:
the forward surface and the first rake surface intersect at a first cutting edge, and
the forward surface and the second rake surface intersect at a second cutting edge.

28. A cutting tool, comprising:
a tool holder extending along a longitudinal axis (L) which defines a forward direction (DF) and an opposite rearward direction (DR), the tool holder comprising:
an insert seat located at a forward end of the tool holder; and
a shank portion extending from the insert seat in the rearward direction (DR); and
a cutting insert according to claim 20, placed in the insert seat.

29. The cutting tool according to claim 28, wherein:
the insert seat comprises:
a seat support surface;
a first seat converging wall, extending transversely to the seat support surface, and having a planar first seat abutment portion located thereon;
a second seat converging wall, extending transversely to the seat support surface, and having a planar second seat abutment portion and a planar third seat abutment portion located thereon, the second and third seat abutment portions being coplanar and spaced apart from one another, the second and third seat abutment portions being parallel to the longitudinal axis (L), and the second seat abutment portion being located forwardly of the third seat abutment portion, along the longitudinal axis (L); and
the cutting insert is placed in the insert seat, such that the first insert abutment portion abuts the first seat abutment portion, the second and third insert abutment portions abut the second and third seat abutment portions, respectively, and the insert back surface abuts the seat support surface.

30. The cutting tool according to claim 29, wherein:
the tool holder further comprises a holder top surface, a holder bottom surface parallel to the holder top surface, a holder front surface, and a holder back surface;
the holder front surface and the holder back surface extend between the holder top surface and the holder bottom surface;
the holder front surface, the second holder side surface, the holder top surface and the holder bottom surface, extend along the longitudinal axis (L).

31. The cutting tool according to claim 30, wherein:
the shank portion has a rectangular cross section;
the holder front surface is parallel to the holder back surface;
the holder top surface is parallel to the holder bottom surface; and
the holder top surface is perpendicular to the holder front surface.

32. The cutting tool according to claim 30, wherein:
the tool holder further comprises a holder forward surface located at the forward end of the tool holder, and extending transversely to the longitudinal axis (L), between the holder front surface, the holder back surface, the holder top surface and the holder bottom surface; and
the holder forward surface intersects the third seat abutment portion.

33. The cutting tool according to claim 29, wherein:
the tool holder further comprises a fastening bore extending transversely to the longitudinal axis (L), and opening out to the seat support surface, and
the cutting insert is attached to the insert seat by a fastening member, passing through the through bore of the cutting insert, and engaging with the fastening bore of the tool holder.

34. The cutting tool according to claim 29, wherein:
a first plane (A1) which includes the first seat abutment portion, and a second plane (A2) which includes the second and third seat abutment portions, converge in the rearward direction (DR), forming the convergence angle (φ) therebetween.

35. A cutting insert having mirror image symmetry about a first symmetry plane and a second symmetry plane, the cutting insert comprising:
a front surface,
a back surface opposite to the front surface,
a mounting hole penetrating the front and back surfaces, the mounting hole having a central axis;
the first symmetry plane being orthogonal to the central axis and passing in-between the front and back surfaces;
the second symmetry plane containing the central axis; and
a peripheral side surface formed parallel to the central axis and connecting the front and back surfaces, the peripheral side surface comprising:
a first cutting part including a first cutting edge parallel to the central axis, a first rake face and a first flank adjoining the first cutting edge;
a second cutting part including a second cutting edge parallel to the central axis, a second rake face and a second flank adjoining the second cutting edge, the second cutting part having mirror image symmetry with respect to the first cutting part about the second symmetry plane;
a base end portion on a side opposite to a tip portion, the tip portion being provided with the first and second cutting part, the second symmetry plane passing through the base end portion and the tip portion;
a third flat plane contiguous with the first rake face;
a fourth flat plane contiguous with the second rake face, the fourth plane having mirror image symmetry with respect to the third flat plane about the second symmetry plane;
a first flat plane between the third flat plane and a first base end of the base end portion;
a second flat plane between the fourth flat plane and a second base end of the base end portion, the second flat plane having mirror image symmetry with respect to the first flat plane, about the second symmetry plane; and
the first flank includes a ridge line of the first cutting edge and has a positive clearance angle with respect to a third reference plane orthogonal to the second flat plane or a virtual plane extending the second flat plane.

36. The cutting insert according to claim 35, wherein:
the third flat plane is formed parallel to the second flat plane; and
the fourth flat plane having the mirror image symmetry with respect to the third flat plane based on the second symmetry plane is formed parallel to the first flat plane.

37. The cutting insert according to claim 35, wherein:
a distance from a line of intersection at which a virtual plane extending from the first flat plane and a virtual plane extending from the second flat plane intersect each other to the central axis is longer than a distance from the ridge line of the first cutting edge to the central axis.

38. The cutting insert according to claim 35, wherein:
the front surface and the back surface are divided into a thick-walled region in which the mounting hole is arranged, and a thin-walled region in which a plate thickness between the front surface and the back surface is smaller than that of the thick-walled region; and
both the first flat plane and the second flat plane are formed so as to span a portion where the peripheral side surface is adjoined with the thick-walled region and a portion where the peripheral side surface is adjoined with the thin-walled region.

39. The cutting insert according to claim 35, wherein:
the line of intersection where the third reference plane and the virtual plane extending from the second flat plane intersect each other is such that a distance of the second flat plane from the tip is equal to or less than a blade width of the first cutting edge.
